(19) United States
(12) Patent Application Publication
(10) Pub. No.: US 2009/0306154 A1
(43) Pub. Date: Dec. 10, 2009

(54) SYNERGISTIC ANTI-MICROBIAL MIXTURES OF TROPOLONE (DERIVATIVES) AND SELECTED COMPOUNDS

(75) Inventors: Ravikumar Pillai, Emerson, NJ (US); Gerhard Schmaus, Hoxter (DE)

Correspondence Address: CONNOLLY BOVE LODGE & HUTZ LLP, 1875 EYE STREET, N.W., SUITE 1100, WASHINGTON, DC, 20006, US

(73) Assignee: SYMRISE GMBH & CO., KG, HOLZMINDEN (DE)

(21) Appl. No.: 12/373,076

(22) PCT Filed: Jun. 29, 2007
(86) PCT No.: PCT/EP07/56573

§ 371 Date: Aug. 27, 2009

Related U.S. Application Data
(60) Provisional application No. 60/807,244, filed on Jul. 13, 2006.

(51) Int. Cl. A01N 35/06; A01N 47/12; A01N 43/50; A01N 37/52; A01P 1/00; A01N 43/80; A23L 3/34

(52) U.S. Cl. 514/361; 514/675; 514/479; 514/396; 514/398; 514/635; 514/372; 426/532

(57) ABSTRACT

The present invention relates to the antimicrobial mixture comprising or consisting of:
(a) one, two or more tropolone derivatives of the formula (1)

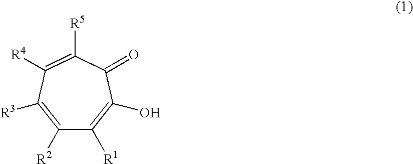

wherein the substituents R¹, R², R³, R⁴, R⁵ independently of one another have the following meaning:
H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I
or salts or solvates thereof
and
(b) one or more compounds selected from the group consisting of:
chlorphenesin, imidazolidinyl urea, DMDM hydantoin, ethylhexylglycerin, diazolidinyl urea, sodium hydroxymethylglycinate and polyaminopropyl biguanide or salts or solvates thereof.

### CROSS-REFERENCE TO RELATED APPLICATIONS

This application claims benefit of priority to PCT/EP2007/056573, filed on Jun. 29, 2007, which asserts priority to U.S. Provisional Application No. 60/807,244, filed on Jul. 13, 2006, which are incorporated herein by reference in their entireties.

The present invention relates to the field of antimicrobial active compounds, and in particular certain mixtures, formulations and foodstuffs comprising one or more tropolone (derivatives) of the formula (1) (in this context, see below) and one or more specific selected compounds (in this context, see below), and to products comprising such mixtures in an antimicrobially active amount.

This invention also relates to certain uses and processes in which the mixtures according to this invention are employed.

In the cosmetics and pharmaceutical and in the foodstuffs industry there is a constant need for agents having antimicrobial properties, in particular for the preservation of products which are otherwise perishable (such as e.g. cosmetics, pharmaceutical products or foodstuffs), but also for direct cosmetic or therapeutic treatment of microorganisms which can have an adverse influence on the human or animal body. Reference may be made by way of example to microorganisms which can cause body odor, acne, mycoses or the like.

In the technical fields referred to a large number of antimicrobial active compounds are indeed already employed, but alternatives nevertheless continue to be sought, in order to be able to perform targeted specific treatments and/or reduce side effects. In this context, however, in the search for alternative agents having an antimicrobial and in particular preserving action it is to be noted that the substances used in the cosmetics, pharmaceutical and/or foodstuffs field must be
toxicologically acceptable,
readily tolerated by the skin,
stable (in particular in the conventional cosmetic and/or pharmaceutical formulations),
largely and preferably completely odorless and
inexpensive to prepare (i.e. employing standard processes and/or starting from standard precursors).

The search for suitable (active) substances which have one or more of the properties mentioned to an adequate extent is made difficult for the person skilled in the art in that there is no clear dependency between the chemical structure of a substance on the one hand and its biological activity against certain microorganisms (germs) and its stability on the other hand. Furthermore, there is no predictable connection between the antimicrobial action, the toxicological acceptability, the skin tolerability and the stability of a substance.

According to a first aspect, the present invention relates to an antimicrobial mixture comprising or consisting of:

(a) one, two or more tropolone derivatives of the formula (1)

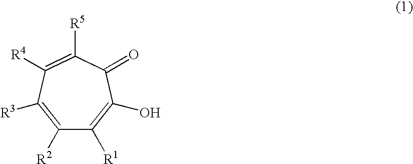

wherein the substituents R¹, R², R³, R⁴, R⁵ independently of one another have the following meaning:

H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I,

or salts or solvates thereof

and

(b) one or more, preferably one, two, three, four or five compounds selected from the group consisting of:

chlorphenesin, imidazolidinyl urea, DMDM hydantoin, ethylhexylglycerin, diazolidinyl urea, sodium hydroxymethylglycinate and polyaminopropyl biguanide or (different) salts or solvates thereof.

The selected compounds of constituent (b) are also known as:
3-(4-chlorophenoxy)-1,2-propanediol (CAS Number: 104-29-0; INCI: Chlorphenesin)
Urea, N,N″-methylenebis(N′-(3-(hydroxymethyl)-2,5-dioxo-4-imidazolidinyl)—(CAS Number: 39236-46-9; INCI: Imidazolidinyl Urea)
2,3-Imidazolidinedione,1,3-bis(hydroxymethyl)-5,5-dimethyl—(CAS Number: 6440-58-0; INCI: DMDM Hydantoin)
2-Ethylhexylglycerylether (CAS Number: 70445-33-9; INCI: Ethylhexylglycerin)
Urea, N-(1,3-bis(hydroxymethyl)-2,5-dioxo-4-imidazolidinyl)-N,N′-bis(hydroxymethyl)—(CAS Number: 78491-02-8; INCI: Diazolidinyl urea)
Sodium N-hydroxymethyl-glycinate (N-(Hydroxymethyl)glycine, monosodium salt; CAS Number: 70161-44-3; INCI: Sodium hydroxymethylglycinate)
Poly(hexamethylene diguanide) (-hydrochloride) (CAS Numbers: 70170-61-5, 28757-47-3; INCI: Polyaminopropyl biguanide)

The constituents (a) and (b) in the antimicrobial mixture according to this invention are preferably adjusted in such a way that their antimicrobial action is intensified synergistically.

Compounds which are preferred for use as constituent (a) in antimicrobial mixtures according to this invention are:

tropolone (formula (I): R⁵, R⁶, R⁷, R⁸, R⁹═H),

alpha-thujaplicin (formula (I): R⁵=iso-propyl, R⁶, R⁷, R⁸, R⁹═H)

beta-thujaplicin (formula (I): R⁶=iso-propyl, R⁵, R⁷, R⁸, R⁹═H)

gamma-thujaplicin (formula (I): R⁷=iso-propyl, R⁵, R⁶, R⁸, R⁹═H)

or a mixture of these compounds.

The structural formula of the compound tropolone (CAS No.: 533-75-5; 2,4,6-cycloheptatrien-1-one, 2-hydroxy), which is particularly preferred for use in a mixture according to this invention, is:

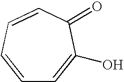

Compounds which are preferred for use as constituent (b), preferably one, two, three or four compounds of constituent (b) are selected from the group consisting of:

chlorphenesin, imidazolidinyl urea, DMDM hydantoin and ethylhexylglycerol

or

(different) salts or solvates thereof.

This invention is based on the surprising finding that the mixtures according to this invention show a synergistically intensified antimicrobial effect at least against selected germs, in particular against Aspergillus niger, a mould which can be combated only with great difficulty, and also against other germs.

In particular, it has been found that the mixtures according to this invention can be used outstandingly as an antimicrobial active compound mixture, in particular for preserving otherwise perishable articles (see above).

The antimicrobial action of tropolone and tropolone derivatives is known e.g. from Antimicrob. Agents Chemother. vol. 7(5), 500-506 (1975). However, studies of a synergistically intensified activity against Aspergillus niger of a combination of tropolone with the specific selected certain compounds of component (b) according to this invention to be employed according to this invention are not disclosed in this these publication.

In PCT/EP2006/050425 antimicrobial active mixtures are disclosed, comprising or consisting of

(a) one or more branched or unbranched alkanediols having 6-12 carbon atoms,

and

(b) one, two or more compounds chosen from the group consisting of the tropolones of the formula (I)

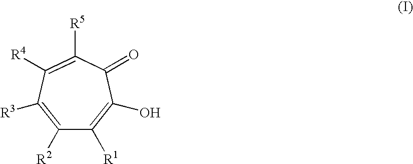

wherein the substituents R¹, R², R³, R⁴, R⁵ independently of one another have the following meaning:

H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I.

In PCT/EP2006/063264 antimicrobial active mixtures are disclosed, comprising or consisting of

(a) one or more compounds of the formula (I)

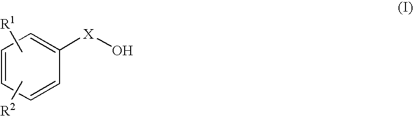

their salts or solvates,

wherein R¹ and R² in each case independently of one another are chosen from the group consisting of: H, OH, F, Cl, Br and I,

and wherein X in each case denotes:

(CH₂)ₘ where m=1, 2 or 3

or

O—(—CH₂—)ₙ—, where n=1, 2 or 3

or

O—CH₂—CH(R³), where R³═CH₃ or CH₂OH

Or

(CH₂—O—)ₚ—CH₂, where p=1 or 2,

wherein in the compound(s) of the formula (I)

a primary alcohol function CH₂OH is optionally replaced by a radical which is chosen from the group consisting of CH₂OR⁴, COOH and COOR⁴

and/or

a secondary alcohol function CHOH is optionally replaced by the radical CHOR⁴,

wherein each R⁴ denotes an aliphatic or aromatic radical, independently of the meaning of further radicals,

and

(b) one, two or more compounds chosen from the group consisting of the tropolones of the formula (11)

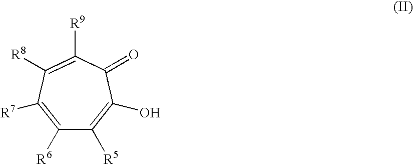

wherein the substituents R⁵, R⁶, R⁷, R⁸, R⁹ independently of one another have the following meaning:

H; linear or branched, saturated or unsaturated, aliphatic hydrocarbon radical having up to 30 C atoms; OH; OR¹⁰, wherein R¹⁰ is a linear or branched, saturated or unsaturated, aliphatic hydrocarbon radical having up to 30 C atoms; COOH; COOR¹¹, wherein R¹¹ is a linear or branched, saturated or unsaturated, aliphatic hydrocarbon radical having up to 30 C atoms; NO₂, NH₂, F, Cl, Br or I.

As additional preservatives amongst a long list of preservatives and anti-microbial compounds chlorphenesin, imidazolidinyl urea, DMDM hydantoin, ethylhexylglycerin, diazolidinyl urea, sodium hydroxymethylglycinate and polyaminopropyl biguanide are disclosed in PCT/EP2006/050425 or PCT/EP2006/063264.

However, the studies regarding the synergistic activity of alkanediols and tropolone derivatives of formula (I) according to PCT/EP2006/050425 or compounds of formula (I) and (II) according to PCT/EP2006/063264 do not disclose any synergistic effect against germs, in particular Aspergillus niger of a mixture of tropolone derivatives of formula (1) and one, two, three, four, five, six or seven compounds selected from the group consisting of:

chlorphenesin, imidazolidinyl urea, DMDM hydantoin, ethylhexylglycerin, diazolidinyl urea, sodium hydroxymethylglycinate and polyaminopropyl biguanide

or (different) salts or solvates thereof.

The antimicrobial mixtures disclosed and/or claimed in PCT/EP2006/050425 and/or PCT/EP2006/063264 are not part of this invention.

A further embodiment of this invention relates to an antimicrobial mixture comprising:

(a) one, two or more tropolone derivatives of the formula (1)

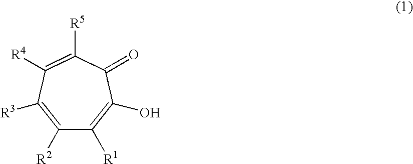

wherein the substituents R¹, R², R³, R⁴, R⁵ independently of one another have the following meaning:

H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I

or salts or solvates thereof

and

(b) chlorphenesin, imidazolidinyl urea, DMDM hydantoin, ethylhexylglycerin, diazolidinyl urea, sodium hydroxymethylglycinate and polyaminopropyl biguanide

or (different) salts or solvates thereof

with the proviso that the antimicrobial mixture does not comprise

i) any further aromatic alcohols, in particular any further aromatic alcohols as described in PCT/EP2006/063264 as constituent (a)

and/or

ii) any alkanediols, in particular any branched or unbranched alkanediols as described in PCT/EP2006/050425 as constituent (a).

A further embodiment of this invention relates to an antimicrobial mixture comprising:

(a) one, two or more tropolone derivatives of the formula (1)

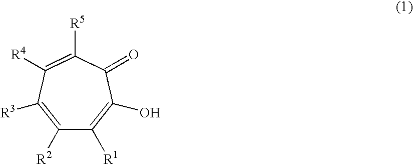

wherein the substituents R¹, R², R³, R⁴, R⁵ independently of one another have the following meaning:

H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I

or salts or solvates thereof

and

(b) chlorphenesin, imidazolidinyl urea, DMDM hydantoin, ethylhexylglycerin, diazolidinyl urea, sodium hydroxymethylglycinate and polyaminopropyl biguanide

or (different) salts or solvates thereof

with the proviso that the antimicrobial mixture does not further comprise

i) one or more compounds of formula (I)

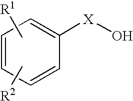

their salts or solvates,

wherein R¹ and R² in each case independently of one another are chosen from the group consisting of: H, OH, F, Cl, Br and I,

and wherein X in each case denotes:

(CH₂)ₘ where m=1, 2 or 3

or

O—(—CH₂—)ₙ—, where n=1, 2 or 3

or

O—CH₂—CH(R³), where R³═CH₃ or CH₂OH

or

(CH₂—O—)ₚ—CH₂, where p=1 or 2,

wherein in the compound(s) of the formula (I)

a primary alcohol function CH₂OH is optionally replaced by a radical which is chosen from the group consisting of CH₂OR⁴, COOH and COOR⁴

and/or

a secondary alcohol function CHOH is optionally replaced by the radical CHOR⁴,

wherein each R⁴ denotes an aliphatic or aromatic radical, independently of the meaning of further radicals

and/or

ii) one or more branched or unbranched 1,2-alkanediols having 6-12 carbon atoms.

Another embodiment of this invention relates to an antimicrobial mixture comprising

(a) one, two or more tropolone derivatives of the formula (1)

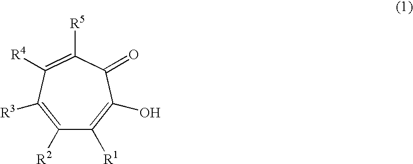

wherein the substituents R¹, R², R³, R⁴, R⁵ independently of one another have the following meaning:

H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I

or salts or solvates thereof

and

(b) one or more compounds selected from the group consisting of:

chlorphenesin, imidazolidinyl urea, DMDM hydantoin, ethylhexylglycerin, diazolidinyl urea, sodium hydroxymethylglycinate and polyaminopropyl biguanide

or (different) salts or solvates thereof,

with the proviso that the antimicrobial mixture does not further comprise

i) one or more compounds of formula (I)

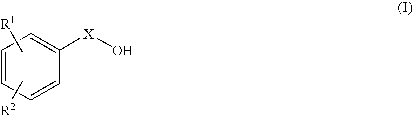

or their salts or solvates

selected from the group consisting of:
benzyl alcohol, 2-phenylethyl alcohol, 2-phenoxyethanol, 3-phenoxypropanol, 1-phenoxy-propan-2-ol, 3-phenoxy-propane-1,2-diol and the derivatives of these alcohols in which a primary alcohol function CH₂OH is replaced by a radical which is chosen from the group consisting of: CH₂OR⁴, COOH and COOR⁴, where R⁴=aliphatic or aromatic radical and/or a secondary alcohol function CHOH is replaced by the radical CHOR⁴, where R⁴=aliphatic or aromatic radical or
benzyloxymethanol and (benzyloxymethoxy)-methanol

and/or

ii) one or more compounds selected from the group:

1,2-hexanediol, 1,2-octanediol or 1,2-decanediol

or

a mixture of 1,2-hexanediol and 1,2-octanediol or a mixture of 1,2-hexanediol and 1,2-decanediol or a mixture of 1,2-octanediol and 1,2-decanediol or a mixture of 1,2-hexanediol, 1,2-octanediol and 1,2-decanediol.

The specific selected compounds of component (b) to be employed according to this invention usually per se have only a deficient action, for example, against moulds such as Aspergillus niger. In respect of individual constituents of component (a) or (b), a gap in the activity on moulds (e.g. the “problem germ” Aspergillus niger) is thus to be recorded. High use concentrations of individual aromatic alcohols have therefore hitherto been necessary for complete inhibition of moulds.

It was therefore particularly surprising that the mixtures according to this invention show a highly synergistic activity, and in the treatment of Aspergillus niger are significantly superior to
indvidually dosed tropolones or tropolone derivatives of the formula (1) or mixtures of tropolone (derivatives) of the formula (1) or
individually dosed compounds selected the group consisting of
chlorphenesin,
imidazolidinyl urea,
DMDM hydantoin,
ethylhexylglycerin,
diazolidinyl urea
sodium hydroxymethylglycinate and
polyaminopropyl biguanide
or (different) salts or solvates or mixtures of these compounds

at the same concentration, in particular in respect of the reduction in germ count and the speed of the reduction in germ count.

On the basis of the particularly significant intensification in the action of their constituents, mixtures according to this invention are suitable in particular for combating Aspergillus niger even at a low dosage of the mixture according to this invention.

For the preparation of effective mixtures according to this invention which cause a particularly rapid reduction in the Aspergillus niger germ count, it is sufficient to mix one mixture constituent (a), such as preferably one, two or more tropolone derivatives, derivatives of formula (1), tropolone, alpha-thujaplicin, beta-thujaplicin, or gamma-thujaplicin, more preferred tropolone, for example an amount of (a) in the range of 0.01-10 wt. %, preferably only 0.5-4 wt. %, based on the amount of constituent (b). If an amount of 0.2 wt. % e.g. of chlorphenesin is employed, this corresponds e.g. to an amount of tropolone(s) of just about 0.005 wt. %, in each case based on the total weight of the end product.

Based on the total weight of constituents (a) and (b) to be employed according to this invention, the content of constituent (b) is preferably in the range of from 80 to 99.99 wt. %, but preferably in the range of 94-99.5 wt. %.

The antimicrobial mixtures according to this invention are suitable for preservation and antimicrobial treatment of perishable products, such as e.g. cosmetic products, pharmaceutical products or foods (foodstuffs).

A cosmetic or pharmaceutical formulation according to this invention or a foodstuff according to this invention comprises
a mixture which is antimicrobial according to this invention and comprises or consists of constituents (a) and (b) as stated above and
further conventional constituents,

the total amount of constituents (a) and (b) being in the range of from 0.01 to 10 wt. %, based on the total weight of the formulation or of the foodstuff.

In one embodiment a cosmetic or pharmaceutical formulation according to this invention or a foodstuff according to this invention comprises
a mixture which is antimicrobial according to this invention and comprises or consists of constituents (a) and (b) as stated above and
further conventional constituents,

the total amount of constituents (a) and (b) being in the range of from 0.01 to 10 wt. %, based on the total weight of the formulation or of the foodstuff with the proviso that the formulation or the foodstuff does not comprise as a further constituent

i) any further aromatic alcohols, in particular any further aromatic alcohols as described in PCT/EP2006/063264 as constituent (a)

and/or

ii) any alkanediols, in particular any branched or unbranched alkanediols as described in PCT/EP2006/050425 as constituent (a).

In a further embodiment this invention relates to a cosmetic or pharmaceutical formulation according to this invention or a foodstuff according to this invention comprising:
a mixture which is antimicrobial according to this invention and comprises or consists of constituents (a) and (b) as stated above and
further conventional constituents,

the total amount of constituents (a) and (b) being in the range of from 0.01 to 10 wt. %, based on the total weight of the formulation or of the foodstuff

with the proviso that the formulation or the foodstuff does not comprise as a further constituent

i) one or more compounds of formula (I)

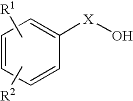

their salts or solvates,

wherein R¹ and R² in each case independently of one another are chosen from the group consisting of: H, OH, F, Cl, Br and I,

and wherein X in each case denotes:

(CH₂)ₘ where m=1, 2 or 3

or

O—(—CH₂—)ₙ—, where n=1, 2 or 3

or

O—CH₂—CH(R³), where R³═CH₃ or CH₂OH

or

(CH₂—O—)ₚ—CH₂, where p=1 or 2,

wherein in the compound(s) of the formula (I)

a primary alcohol function CH₂OH is optionally replaced by a radical which is chosen from the group consisting of CH₂OR⁴, COOH and COOR⁴

and/or

a secondary alcohol function CHOH is optionally replaced by the radical CHOR⁴,

wherein each R⁴ denotes an aliphatic or aromatic radical, independently of the meaning of further radicals

and/or

ii) one or more branched or unbranched 1,2-alkanediols having 6-12 carbon atoms.

Another embodiment of this invention relates to a cosmetic or pharmaceutical formulation according to this invention or a foodstuff according to this invention comprising:
a mixture which is antimicrobial according to this invention and comprises or consists of constituents (a) and (b) as stated above and
further conventional constituents,

the total amount of constituents (a) and (b) being in the range of from 0.01 to 10 wt. %, based on the total weight of the formulation or of the foodstuff

with the proviso that the formulation or the foodstuff does not comprise as a further constituent

i) one or more compounds of formula (I)

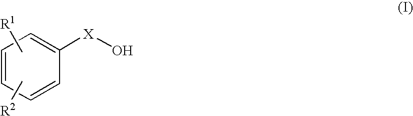

or their salts or solvates

selected from the group consisting of:
benzyl alcohol, 2-phenylethyl alcohol, 2-phenoxyethanol, 3-phenoxypropanol, 1-phenoxy-propan-2-ol, 3-phenoxy-propane-1,2-diol and the derivatives of these alcohols in which a primary alcohol function CH₂OH is replaced by a radical which is chosen from the group consisting of: CH₂OR⁴, COOH and COOR⁴, where R⁴=aliphatic or aromatic radical and/or a secondary alcohol function CHOH is replaced by the radical CHOR⁴, where R⁴=aliphatic or aromatic radical or
benzyloxymethanol and (benzyloxymethoxy)-methanol

and/or

ii) one or more compounds selected from the group:

1,2-hexanediol, 1,2-octanediol or 1,2-decanediol

or

a mixture of 1,2-hexanediol and 1,2-octanediol or a mixture of 1,2-hexanediol and 1,2-decanediol or a mixture of 1,2-octanediol and 1,2-decanediol or a mixture of 1,2-hexanediol, 1,2-octanediol and 1,2-decanediol.

For the preparation of such a formulation or such a foodstuff, the corresponding (conventionally otherwise perishable) product is brought into contact with an antimicrobially active amount, preferably an amount which is active against Aspergillus niger, of an antimicrobial mixture according to this invention.

On the basis of their synergistically intensified antimicrobial activity, however, the mixtures according to this invention can also be employed
(a) for the cosmetic treatment of microorganisms which cause body odor,
(b) for the cosmetic treatment of microorganisms which cause acne,
(c) for the cosmetic treatment of microorganisms which cause mycoses and
(d) for the treatment of microorganisms on or in inanimate matter.

On the basis of the synergistic action of constituents (a) and (b) in an antimicrobial mixture or formulation according to this invention or a corresponding foodstuff, an adequate antimicrobial activity can already be achieved if the amount of constituent (a) and/or the amount of constituent (b) in each case considered in itself is not antimicrobially active. However, the total amount of constituents (a) and (b) is then antimicrobially active.

The present invention also relates to the use of an antimicrobial mixture according to this invention as an antimicrobial active compound mixture. In this context, that stated above applies accordingly in respect of the compounds of constituents (a) and (b) which are preferably to be employed.

The mixtures according to this invention display their synergistically intensified antimicrobial action against a large number of Gram-positive bacteria, Gram-negative bacteria, moulds and yeasts, which in particular renders possible preservation and antimicrobial treatment of a large number of cosmetic formulations. A particularly good action exists against Gram-negative bacteria, such as Escherichia coli (preferably tested on strain ATCC 8739) and Pseudomonas aeruginosa (preferably strain ATCC 90270), Staphylococcus albicans (preferably tested on strain ATCC 6538) against yeasts, such as Candida albicans (preferably tested on strain ATCC 10231), and precisely—as already mentioned—against fungi, such as Aspergillus niger (preferably tested on strain ATCC 16404). The very good activity of the mixtures according to this invention against Aspergillus niger, a mould which can be combated only with great difficulty, is to be regarded as particularly advantageous here.

The present invention furthermore relates to corresponding methods for the cosmetic and/or therapeutic treatment of germs, in particular on the human body, and in particular especially of (i) microorganisms which cause body odor, (ii) microorganisms which cause acne and/or (iii) microorganisms which cause mycoses, comprising topical application of an antimicrobially active amount of a mixture according to this invention. The contents of the said constituents (a) and (b) of the mixtures are therefore preferably adjusted such that their antimicrobial action is intensified synergistically.

Preferred embodiments of the methods according to this invention correspond to the preferred embodiments of the use according to this invention which are explained above.

The human skin is populated by a large number of various microorganisms, which include the microorganisms already mentioned above, as well as others. Most of these microorganisms are not pathogenic and are irrelevant to the physiological state of the skin and to the odor thereof. On the other hand, others can influence the healthy state of the skin decisively.

As our own studies have now shown, the synergistically active mixtures according to this invention have a good action against Staphylococcus epidermidis, Corynebacterium xerosis, Brevibacterium epidermidis, Propionibacterium acnes and against Trichophyton and Epidermophyton species, SO that they can be employed as agents for the treatment of (combating) underarm and foot odor or body odor generally, as agents for combating acne, as antidandruff agents and for the treatment of mycoses (in particular dermatomycoses).

In the context of the present invention, “treatment” is understood here as meaning any form of influencing of the microorganisms in question in which the multiplication of these microorganisms is inhibited and/or the microorganisms are killed.

The use concentration of a mixture according to this invention (which is preferably in a preferred embodiment) when used as a preservative or antimicrobial active compound in a foodstuff or a cosmetic or pharmaceutical formulation is preferably in the range of from 0.01 to 10 wt. %, but particularly preferably in the range of from 0.05 to 5 wt. %, in each case based on the total weight of the foodstuff or the formulation. The foodstuff and formulation additionally comprise conventional further constituents, in this context see below. The particular content of constituents (a) and/or (b) to be used according to this invention in mixtures according to this invention can be below the amount regarded as antimicrobially active in itself if the total amount of these substances which is present is sufficiently high to achieve an antimicrobial action of the total mixture. This applies in particular to the action against Aspergillus niger.

In a preferred method according to this invention for the cosmetic and/or therapeutic treatment of (i) microorganisms which cause body odor, (ii) microorganisms which cause acne and/or (iii) microorganisms which cause mycoses, the use concentration of the synergistically active mixtures according to this invention is also in the range between 0.01 and 10 wt. %, and particularly preferably in the range between 0.05 and 5 wt. %, in each case based on the total weight of the cosmetic or pharmaceutical product which comprises the mixture.

The synergistically active mixtures can be employed here (a) prophylactically or (b) as required.

The concentration of the amount of active compound to be applied e.g. daily varies and depends on the physiological state of the subject and individual-specific parameters, such as age or body weight. The synergistically active mixtures according to this invention can be employed either by themselves or in combination with further antimicrobially active substances.

Further uses/methods and mixtures/compositions according to this invention can be found in the following statements and the attached patent claims.

Compositions which comprise a mixture according to this invention are, especially if they are employed against germs which cause body odor, as a rule applied topically in the form of solutions, creams, lotions, gels, sprays or the like. For other purposes, an oral (tablets, capsules, powders, drops), intravenous, intraocular, intraperitoneal or intramuscular administration or an administration in the form of an impregnated dressing is appropriate in some cases.

The mixtures according to this invention can be incorporated without difficulties into the usual cosmetic and/or dermatological formulations, such as, inter alia, pump sprays, aerosol sprays, creams, ointments, tinctures, lotions, nail care products (e.g. nail varnishes, nail varnish removers, nail balsams) and the like. It is also possible here, and in some cases advantageous, to combine the synergistic mixtures according to this invention with further active compounds, for example with other antimicrobially, antimycotically or antivirally active substances. The cosmetic and/or dermatological/keratological formulations comprising the synergistic mixtures according to this invention can otherwise have the conventional composition here and serve for the treatment of skin and/or hair in the sense of a dermatological treatment or a treatment in the sense of care cosmetics. However, they can also be employed in make-up products in decorative cosmetics.

If the mixtures according to this invention are employed as active compounds for preserving organic material, one or more further preservatives can advantageously additionally be employed as constituent(s) (c). Preservatives which are preferably chosen here are those such as 2,4-hexadienoic acid (sorbic acid) and its salts, formaldehyde and paraformaldehyde, 2-hydroxybiphenyl ether and its salts, 2-zinc-sulfidopyridine N-oxide, inorganic sulfites and bisulfites, sodium iodate, chlorobutanolum, 4-ethylmercury-(II)5-amino-1,3-bis(2-hydroxybenzoic acid), its salts and esters, dehydracetic acid, formic acid, 1,6-bis(4-amidino-2-bromophenoxy)-n-hexane and its salts, the sodium salt of ethylmercury-(II)-thiosalicylic acid, phenylmercury and its salts, 10-undecylenic acid and its salts, 5-amino-1,3-bis(2-ethylhexyl)-5-methyl-hexahydropyrimidine, 5-bromo-5-nitro-1,3-dioxane, 2-bromo-2-nitro-1,3-propanediol, N-(4-chlorophenyl)-N′-(3,4-dichlorophenyl)-urea, 4-chloro-m-cresol, 2,4,4′-trichloro-2′-hydroxy-diphenyl ether, 4-chloro-3,5-dimethylphenol, 1,1′-methylene-bis(3-(1-hydroxymethyl-2,4-dioximidazolidin-5-yl)urea), poly-(hexamethylenediguanide)hydrochloride, hexamethylenetetramine, 1-(3-chloroallyl)-3,5,7-triaza-1-azonia-adamantane chloride, 1-(4-chlorophenoxy)-1-(1H-imidazol-1-yl)-3,3-dimethyl-2-butanone, 1,3-bis-(hydroxymethyl)-5,5-dimethyl-2,4-imidazolidinedione, Octopirox, 1,2-dibromo-2,4-dicyanobutane, benzethonium chloride 2,2′-methylene-bis(6-bromo-4-chlorophenol), bromochlorophene, mixture of 5-chloro-2-methyl-3(2H)-isothiazolinone and 2-methyl-3(2H)-isothiazolinone with magnesium chloride and magnesium nitrate, 2-benzyl-4-chlorophenol, 2-chloroacetamide, chlorhexidine, chlorhexidine acetate, chlorhexidine gluconate, chlorhexidine hydrochloride, N-alkyl(C₁₂-C₂₂)trimethyl-ammonium bromide and chloride, 4,4-dimethyl-1,3-oxazolidine, N-hydroxymethyl-N-(1,3-di(hydroxymethyl)-2,5-dioxoimidazolidin-4-yl)-N′-hydroxy-methylurea, 1,6-bis(4-amidino-phenoxy)-n-hexane and its salts, glutaraldehyde, 5-ethyl-1-aza-3,7-dioxabicyclo(3.3.0)octane, hyamines, alkyl-(C₈-C₁₈)-dimethyl-benzyl-ammonium chloride, alkyl-(C₈-C₁₈)-dimethyl-benzylammonium bromide, alkyl-(C₈-C₁₈)-dimethyl-benzyl-ammonium saccharinate, benzyl hemiformal, 3-iodo-2-propynyl butylcarbamate, sodium hydroxymethyl-aminoacetate or sodium hydroxymethyl-aminoacetate, methylchloroisothiazolinone and methylisothiazolinones as well as certain 1,2-alkanediols.

A preferred aspect of the present invention relates to the antimicrobial mixture as described hereinbefore in combination with one or more branched or unbranched 1,2-alkanediols having 6 to 12 carbon atoms as constituent (c). Particularly preferred are combinations of the antimicrobial mixture as described hereinbefore further comprising one or more compounds selected from the group consisting of:

1,2-hexanediol or 1,2-octanediol or 1,2-decanediol

or

a mixture of 1,2-hexanediol and 1,2-octanediol or a mixture of 1,2-hexanediol and 1,2-decanediol or a mixture of 1,2-octanediol and 1,2-decanediol or a mixture of 1,2-hexanediol, 1,2-octanediol and 1,2-decanediol.

Antimicrobial mixtures which, in addition to constituents (a) and (b), also comprise one or more of the 1,2-alkanediols or mixtures thereof mentioned as constituent (c), often have an activity which is particularly synergistically intensified.

If the mixtures according to this invention are to be employed chiefly for inhibition of the growth of undesirable microorganisms on or in animal organisms, a combination with one or more further antibacterial or antimycotic active substances (as additional constituent(s) (c)) is also advantageous here in some cases. In this respect, further active compounds which are worth mentioning, in addition to the large group of conventional antibiotics, are, in particular, the products relevant for cosmetics, such as (triclosan, climbazole, Octopirox (1-hydroxy-4-methyl-6-(2,4,4-trimethylpentyl)-2(1H)-pyridone, 2-aminoethanol), chitosan, totarol, farnesol, geranylacetol, glycerol monolaurate, arylalkyl alcohols, such as e.g. 4-methyl-4-phenyl-2-pentanols (DE 101 43 434, in particular 4-methyl-4-phenyl-2-pentanol), muguet alcohol (2,2-dimethyl-3-phenylpropanol), other arylalkyl alcohols (e.g. as disclosed in DE 44 47 361, DE 103 30 697, U.S. Pat. No. 4,110,430 or EP 1 157 687), essential oils with antimicrobial properties and isolates from essential oils with antimicrobial properties like e.g. thymol or eugenol, perfume oils or single aroma chemicals with antimicrobial activity, polyglycerol esters, such as e.g. polyglyceryl 3-caprylates, or combinations of the substances mentioned, which are employed, inter alia, against underarm odor, foot odor or dandruff formation.

The following preservatives and/or antibacterial or antimycotic active compounds are preferred as one or more additional constituents (c) in combination with an antimicrobial mixture as described hereinbefore wherein the compounds of constituent (c) are selected from the group consisting of:

methylchloroisothiazolinone, methylisothiazolinone, chlorohexidine, benzethonium chloride, 2-bromo-2-nitropropane-1,3-diol, methylpropanediol, dimethyl phenylpropanol and 4-methyl-4-phenyl-2-pentanol

or

(different) salts or solvates thereof.

The preferred compounds of constituents (c) are also known as:
methylchloroisothiazolinone (5-chloro-2-methyl-4-isothiazolin-3-one; CAS Number: 26172-55-4)
methylisothiazolinone (2-methyl-4-isothiazolin-3-one; CAS Number: 2682-20-4)
chlorohexidine (1,1 ′-hexamethylenebis[5-(4-chlorophenyl)biguanide]; CAS Number: 55-56-1)
benzethonium chloride (CAS Number: 121-54-0)
2-bromo-2-nitropropane-1,3-diol (CAS Number: 52-51-7)
methylpropanediol (2-methyl-1,3-propanediol; CAS Number: 2163-42-0)
dimethyl phenylpropanol (2,2-dimethyl-3-phenyl-propan-1-ol; CAS Number: 13351-61-6)

A further preferred aspect of this invention relates to an antimicrobial mixture as described hereinbefore comprising or consisting of
tropolone as constituent (a),
one or more compounds selected from the group consisting of:
chlorphenesin, imidazolidinyl urea, DMDM hydantoin, ethylhexylglycerin, diazolidinyl urea, sodium hydroxymethylglycinate and polyaminopropyl biguanide
or (different) salts or solvates thereof as constituent (b)
and
one or more compounds selected from the group consisting of:
methylchloroisothiazolinone, methylisothiazolinone, chlorohexidine, benzethonium chloride, 2-bromo-2-nitropropane-1,3-diol, methylpropanediol, dimethyl phenylpropanol and 4-methyl-4-phenyl-2-pentanol
or
(different) salts or solvates thereof as constituent (c).

Another embodiment of the present invention relates to an antimicrobial mixture comprising or consisting of
tropolone as constituent (a) and
one, two, three or more compounds selected from the group consisting of:
methylchloroisothiazolinone, methylisothiazolinone, chlorohexidine, benzethonium chloride, 2-bromo-2-nitropropane-1,3-diol, methylpropanediol, dimethyl phenylpropanol and 4-methyl-4-phenyl-2-pentanol
or
(different) salts or solvates thereof as constituent (c).

The mixtures according to this invention comprising or consisting of tropolone as constituent (a) and one or more compounds of constituent(s) (c) as described above

show similar synergistic activities with respect to the relevant germs as described hereinbefore for the antimicrobial mixtures comprising or consisting of compounds of constituent (a) and (b)

and/or

the same or similar suitability as described hereinbefore for antimicrobial mixtures of compounds comprising or consisting of constituent (a) and (b) for preservation and antimicrobial treatment of perishable products, such as e.g. cosmetic products, pharmaceutical products or foods (foodstuffs) according to this invention

and/or

comprise constituents (a) and (c) in the same or similar weight ratio as described hereinbefore for antimicrobial mixtures of compounds comprising or consisting of constituent (a) and (b).

Therefore the mixtures according to this invention comprising or consisting of tropolone as constituent (a) and one or more compounds of constituent(s) (c) as described above

can be used in formulations and/or foodstuffs according to this invention in the same or similar weight ranges as described hereinbefore for antimicrobial mixtures of compounds comprising or consisting of constituent (a) and (b).

The mixtures according to this invention comprising or consisting of tropolone as constituent (a) and one or more compounds of constituent(s) (c) as described above and/or

formulations or foodstuffs according to this invention comprising the mixtures comprising or consisting of tropolone as constituent (a) and one or more compounds of constituent(s) (c) as described above

show the same provisos as described hereinbefore for antimicrobial mixtures of compounds comprising or consisting of constituent (a) and (b) and/or formulations or foodstuffs according to this invention comprising the antimicrobial mixtures of compounds comprising or consisting of constituent (a) and (b) and further conventional constituents.

The mixtures according to this invention comprising or consisting of tropolone as constituent (a) and one or more compounds of constituent(s) (c) as described above and/or

formulations comprising the mixtures according to this invention comprising or consisting of tropolone as constituent (a) and one or more compounds of constituent(s) (c) as described above

can further be used for the cosmetic and/or therapeutic treatment of (i) microorganisms which cause body odor, (ii) microorganisms which cause acne and/or (iii) microorganisms which cause mycoses

in the same or similar weight ranges as described hereinbefore for mixtures or formulations according to this invention comprising or consisting of tropolone as constituent (a) and one or more compounds of constituent(s) (b).

The mixtures according to this invention as described hereinbefore can advantageously be combined, in particular in cosmetic formulations, with further conventional constituents, such as, for example:

Further preservatives, further antimicrobial agents, such as e.g. further antibacterial agents or fungicides, abrasives, antiacne agents, agents against aging of the skin, anticellulitis agents, antidandruff agents, antiinflammatory agents, irritation-preventing agents, irritation-inhibiting agents, antioxidants, astringents, perspiration-inhibiting agents, antiseptic agents, antistatics, binders, buffers, carrier materials, chelating agents, cell stimulants, cleansing agents, care agents, depilatory agents, surface-active substances, deodorizing agents, antiperspirants, softeners, emulsifiers, enzymes, essential oils, fibres, film-forming agents, fixatives, foam-forming agents, foam stabilizers, substances for preventing foaming, foam boosters, gelling agents, gel-forming agents, hair care agents, hair-setting agents, hair-straightening agents, moisture-donating agents, moisturizing substances, moisture-retaining substances, bleaching agents, strengthening agents, stain-removing agents, optically brightening agents, impregnating agents, dirt-repellent agents, friction-reducing agents, lubricants, moisturizing creams, ointments, opacifying agents, plasticizing agents, covering agents, polish, gloss agents, polymers, powders, proteins, re-oiling agents, abrading agents, silicones, skin-soothing agents, skin-cleansing agents, skin care agents, skin-healing agents, skin-lightening agents, skin-protecting agents, skin-softening agents, cooling agents, skin-cooling agents, warming agents, skin-warming agents, stabilizers, UV-absorbing agents, UV filters, detergents, fabric conditioning agents, suspending agents, skin-tanning agents, thickeners, vitamins, oils, waxes, fats, phospholipids, saturated fatty acids, mono- or polyunsaturated fatty acids, a-hydroxy acids, polyhydroxy-fatty acids, liquefiers, dyestuffs, colour-protecting agents, pigments, anticorrosives, aromas, flavouring substances, odoriferous substances, polyols, surfactants, electrolytes, organic solvents or silicone derivatives.

The mixtures according to this invention can moreover also particularly advantageously be employed in combination with perspiration-inhibiting active compounds (antiperspirants) for combating body odor. Perspiration-inhibiting active compounds which are employed are, above all, aluminium salts, such as aluminium chloride, aluminium hydrochloride, nitrate, sulfate, acetate etc. In addition, however, the use of compounds of zinc, magnesium and zirconium may also be advantageous. For use in cosmetic and dermatological antiperspirants, the aluminium salts and—to a somewhat lesser extent—aluminium/zirconium salt combinations have essentially proved suitable. The aluminium hydroxychlorides which are partly neutralized and therefore tolerated better by the skin, but not quite so active, are additionally worth mentioning.

If the mixtures according to this invention are to be employed for antimicrobial treatment of a surface (e.g. of a human or animal body), a combination with (metal) chelators is advantageous in some cases. (Metal) chelators which are preferably to be employed here are, inter alia, α-hydroxy fatty acids, phytic acid, lactoferrin, α-hydroxy acids, such as, inter alia, citric acid, ascorbic acid, lactic acid and malic acid, and humic acids, bile acids, bile extracts, bilirubin, biliverdin or EDTA, EGTA and derivatives thereof.

For use, the cosmetic and/or dermatologically active mixtures according to this invention are applied to the skin and/or hair in a sufficient amount in the conventional manner for cosmetics and dermatics. In this context, cosmetic and dermatological formulations which comprise a mixture according to this invention and additionally act as sunscreen compositions offer particular advantages. These formulations advantageously comprise at least one UVA filter and/or at least one UVB filter and/or at least one inorganic pigment. In this context, the formulations can be in various forms such as are conventionally employed e.g. for sunscreen formulations. They can thus be e.g. a solution, an emulsion of the water-in-oil (W/O) type or of the oil-in-water (O/W) type or a multiple emulsion, for example of the water-in-oil-in-water (W/O/W) type, a gel, a hydrodispersion, a solid stick or also an aerosol.

As mentioned, formulations which comprise a mixture according to this invention can advantageously be combined with substances which absorb UV radiation, the total amount of the filter substances being e.g. 0.01 wt. % to 40 wt. %, preferably 0.1% to 10 wt. %, in particular 1.0 to 5.0 wt. %, based on the total weight of the formulations, in order to provide cosmetic formulations which protect the hair or skin from ultraviolet radiation.

A high content of care substances is regularly advantageous in formulations for topical prophylactic or cosmetic treatment of the skin comprising mixtures according to this invention. According to a preferred embodiment, the compositions comprise one or more animal and/or plant fats and oils having care properties, such as olive oil, sunflower oil, refined soya oil, palm oil, sesame oil, rapeseed oil, almond oil, borage oil, evening primrose oil, coconut oil, shea butter, jojoba oil, sperm oil, beef tallow, neat's foot oil and lard, and optionally further care constituents, such as, for example, fatty alcohols having 8-30 C atoms.

Care substances which can be combined in an outstanding manner with the synergistic mixtures according to this invention moreover also include
ceramides, where ceramides are understood as meaning N-acylsphingosins (fatty acid amides of sphingosin) or synthetic analogues of such lipids (so-called pseudo-ceramides), which significantly improve the water retention capacity of the stratum corneum.
phospholipids, for example soya lecithin, egg lecithin and cephalins
vaseline, paraffin oils and silicone oils; the latter include, inter alia, dialkyl- and alkylarylsiloxanes, such as dimethylpolysiloxane and methylphenylpolysiloxane, as well as alkoxylated and quaternized derivatives thereof.

Cosmetic formulations which comprise mixtures according to this invention can also comprise antioxidants, it being possible for all the antioxidants which are suitable or usual for cosmetic and/or dermatological uses to be used.

Cosmetic formulations which comprise mixtures according to this invention can also comprise vitamins and vitamin precursors, it being possible for all the vitamins and vitamin precursors which are suitable or usual for cosmetic and/or dermatological uses to be used. There are worth mentioning here, in particular, vitamins and vitamin precursors, such as tocopherols, vitamin A, niacin acid and niacinamide, further vitamins of the B complex, in particular biotin, and vitamin C and panthenol and derivatives thereof, in particular the esters and ethers of panthenol and cationically derivatized panthenols, such as e.g. panthenol triacetate, panthenol monoethyl ether and the monoacetate thereof and cationic panthenol derivatives.

Cosmetic formulations which comprise mixtures according to this invention can also comprise antiinflammatory or redness- or itching-alleviating active compounds. All the antiinflammatory or redness- and itching-alleviating active compounds which are suitable or usual for cosmetic and/or dermatological uses can be used here.

Cosmetic formulations which comprise mixtures according to this invention can also comprise active compounds having a skin-lightening or skin-tanning action. According to this invention, all the skin-lightening or skin-tanning active compounds which are suitable or usual for cosmetic and/or dermatological uses can be used here.

Cosmetic formulations which comprise mixtures according to this invention can also comprise anionic, cationic, nonionic and/or amphoteric surfactants, especially if crystalline or microcrystalline solids, for example inorganic micropigments, are to be incorporated into the formulations.

This invention is explained in more detail in the following with the aid of an example. Unless stated otherwise, the data relate to the weight.

### EXAMPLE 1

Comparison of adequate preservation of cosmetic formulations comprising 3-(4-chlorophenoxy)-1,2-propanediol (CARN: 104-29-0; INCI: chlorphenesin; product A, comparative formulation), tropolone (product B, comparative formulation) and a mixture of chlorphenesin and tropolone (product C, example C formulation according to this invention)

Testing for adequate preservation was carried out in accordance with the European Pharmacopoeia. Testing thus comprises contamination of the formulation, if possible in its final condition, with a prescribed inoculum of suitable microorganisms, storage of the inoculated formulation at a certain temperature, removal of samples from the container at certain intervals of time and determination of the number of microorganisms in the samples removed in this way. The preserving properties are adequate if, under the conditions of the test, a clear reduction or, where appropriate, no increase in the germ count results in the inoculated formulations after the prescribed times at the prescribed temperatures. Experimental details of the test procedure are described in the European Pharmacopoeia (ISBN 3-7692-2768-9; Supplement 2001 to the 3rd Edition, page 421-422, chapter 5.1.3).

Aspergillus niger ATCC 16404 strain was used for the tests for adequate preservation, with an initial germ count (CFU/g; “0 value”) of 280 000.

Formulation:

For the tests for adequate preservation, a defined amount of the active compound combination according to this invention (product C) was incorporated into an O/W emulsion. For comparison purposes, the comparison products (product A and B) were incorporated into separate O/W emulsions.

TABLE 1
Formulations with products A, B and C:

| | | | Wt. % | | |
|---|---|---|---|---|---|
| | | | with | Wt. % | Wt. % |
| | INCI name | Manufacturer | “A” | with “B” | with “C” |
| Phase A | | | | | |
| Dracorin CE | Glyceryl | Symrise | 4.0 | 4.0 | 4.0 |
| 614035 | Stearate Citrate | | | | |
| PCL Solid | Stearyl | Symrise | 3.0 | 3.0 | 3.0 |
| 660086 | Heptanoate, | | | | |
| | Stearyl | | | | |
| | Caprylate | | | | |
| Paraffin oil °E | Paraffinum | Parafluid | 7.0 | 7.0 | 7.0 |
| | Liquidum | | | | |
| Lanette 18 | Stearyl Alcohol | Cognis | 1.5 | 1.5 | 1.5 |
| Dracorin GMS | Glyceryl | Symrise | 1.5 | 1.5 | 1.5 |
| 647834 | Stearate | | | | |
| Dow Corning 200 | Dimethicone | Dow Corning | 2.0 | 2.0 | 2.0 |
| fluid | | | | | |
| Phase B | | | | | |
| Water, | Water (Aqua) | | to 100 | to 100 | to 100 |
| demineralized | | | | | |
| Carbopol ETD | Carbomer | Noveon | 0.15 | 0.15 | 0.15 |
| 2050 Polymer | | | | | |
| 3-(4- | Chlorphenesin | Engelhard | 0.10 | — | 0.05 |
| Chlorphenoxy)- | | Corporation | | | |
| 1,2-propandiol | | | | | |
| Tropolone | | Symrise | — | 0.01 | 0.005 |
| Phase C | | | | | |
| Neutralizer AMP- | Amino | Dow/Angus | 0.1 | 0.1 | 0.1 |
| 95 | Methylpropanol | | | | |
| Total: | | | 100.0 | 100.0 | 100.0 |

pH: 5.5

Result:

The results of the preservative stress tests for Aspergillus niger for the active compound combinations investigated, comprising the mixture according to this invention (product C) or the comparison systems (products A and B), clearly show a synergistic effect of the mixture according to this invention (product C). In the case of Aspergillus niger, a germ which is particularly problematic in respect of preservation of industrial products, it was possible to reduce the number of colony-forming units (CFU) from 280000 to 200 within 7 days by using the mixture according to this invention (table 2, see below). In contrast, the active compound contained in product A (chlorphenesin) in a dosage of 0.1 wt. % for comparison purposes rendered possible no such significant reduction in the number of colony-forming units (CFU after 7 days: 189000) in Aspergillus niger, which also applies to product B (tropolone, dosage: 0.01%; CFU after 7 days: 2000). This test series thus shows by way of example that the active compound mixtures according to this invention have an action which is significantly improved synergistically compared with products A (chlorphenesin) and B (tropolone).

TABLE 2
Testing for adequate preservation for product A (comprising
0.1% chlorphenesin), for product B (comprising 0.01% tropolone)
and for product C (mixture according to this invention comprising
0.05% chlorphenesin and 0.005% tropolone).

| | | | C |
|---|---|---|---|
| | | | 0.05% |
| | | | chlorphenesin |
| | A | B | and |
| | 0.1% | 0.01% | 0.005% |
| | chlorphenesin | tropolone | Tropolone |
| | CFU (colony-forming units) | | |
| | Aspergillus niger ATCC 16404 | | |
| 0′ count | 280000 | 280000 | 280000 |
| 2 d | 189000 | 75000 | 170000 |
| 7 d | 189000 | 2000 | 0 |
| 14 d | 208000 | 4800 | 0 |
| 28 d | 265000 | 100 | 0 |

The calculation of the SI value for treatment of Aspergillus niger with a mixture of chlorphenesin and tropolone after an incubation phase of 7 days is shown below by way of example (Table 3, see below). The calculated SI of 0.0505 clearly shows that the mixture is a highly synergistic combination of active compounds. A 3 log reduction in Aspergillus niger CFU's (Colony Forming Units) within at least 7 days, which is a necessary prerequisite for adequate preservation, could be only achieved with product C comprising chlorphenesin and tropolone. It was not possible to calculate the 7-day, 14-day and 28-day SI values, since after this incubation phase the germ counts of product C was 0 (compare Table 2). In these special cases, Kull's equation cannot be used.

TABLE 3
Calculation of the synergy index (SI) at the time 7 days with the
aid of the CFU values for product A (chlorphenesin; dosage:
0.1%), product B (tropolone; dosage: 0.01%) and for the
synergistic mixture according to this invention (ratio of amounts
of product A and product B: 1:1; w/w; dosage of
chlorphenesin: 0.05%; dosage of tropolone: 0.005%);
test germ: Aspergillus niger).

| | | | C |
|---|---|---|---|
| | | | 0.05% |
| | | | chlorphenesin |
| | A | B | and |
| | 0.1% | 0.01% | 0.005% |
| | chlorphenesin | tropolone | Topolone |
| Aspergillus niger: 7 days | 189000 | 2000 | 200 |
| [CFU/ml] | | | |

Kull's equation: SI = C × D/A + C × E/B

| | |
|---|---|
| A: Germ count for | 189000 |
| substance A | |
| B: Germ count for | 2000 |
| substance B | |
| C: Germ count for mixture | 200 |
| A + B | |
| D: Content of A in C | 0.5 |
| E: Content of B in C | 0.5 |
| SI: Synergy index | 0.0505 |

For synergy indices according to Kull's equation see F. C. Kull et al.; Applied Microbiology Vol. 9, pp 538-541 (1961); David C. Steinberg; Cosmetics & Toiletries Vol. 115 (No. 11), pp 59-62; November 2000.

Outstanding results which confirm the superiority of product C according to this invention were likewise obtained in respect of the further test germs.

### EXAMPLE 2

Comparison of adequate preservation of cosmetic formulations comprising Urea,N,N″-methylenebis(N′-(3-(hydroxymethyl)-2,5-dioxo-4-imidazolidinyl)—(CARN: 39236-46-9; INCI: Imidazolidinyl Urea; product A, comparative formulation), tropolone (product B, comparative formulation) and a mixture of Imidazolidinyl Urea and tropolone (product C, formulation according to this invention)

Testing for adequate preservation was carried out in accordance with Example 1 as described hereinbefore.

Formulation:

The formulations A, B and C were prepared according to Example 1.

TABLE 4
Formulations with products A, B and C:

| | | | Wt. % | | |
|---|---|---|---|---|---|
| | | | with | Wt. % | Wt. % |
| | INCI name | Manufacturer | “A” | with “B” | with “C” |
| Phase A | | | | | |
| Dracorin CE | Glyceryl | Symrise | 4.0 | 4.0 | 4.0 |
| 614035 | Stearate Citrate | | | | |
| PCL Solid | Stearyl | Symrise | 3.0 | 3.0 | 3.0 |
| 660086 | Heptanoate, | | | | |
| | Stearyl | | | | |
| | Caprylate | | | | |
| Paraffin oil °E | Paraffinum | Parafluid | 7.0 | 7.0 | 7.0 |
| | Liquidum | | | | |
| Lanette 18 | Stearyl Alcohol | Cognis | 1.5 | 1.5 | 1.5 |
| Dracorin GMS | Glyceryl | Symrise | 1.5 | 1.5 | 1.5 |
| 647834 | Stearate | | | | |
| Dow Corning 200 | Dimethicone | Dow Corning | 2.0 | 2.0 | 2.0 |
| fluid | | | | | |
| Phase B | | | | | |
| Water, | Water (Aqua) | | to 100 | to 100 | to 100 |
| demineralized | | | | | |
| Carbopol ETD | Carbomer | Noveon | 0.15 | 0.15 | 0.15 |
| 2050 Polymer | | | | | |
| Urea, N,N″- | Imidazolidinyl | ISP | 0.20 | — | 0.1 |
| methylenebis(N′- | Urea | | | | |
| (3- | | | | | |
| (hydroxymethyl)- | | | | | |
| 2,5-dioxo-4- | | | | | |
| imidazolidinyl)- | | | | | |
| Tropolone | | Symrise | — | 0.01 | 0.005 |
| Phase C | | | | | |
| Neutralizer AMP- | Amino | Dow/Angus | 0.1 | 0.1 | 0.1 |
| 95 | Methylpropanol | | | | |
| Total: | | | 100.0 | 100.0 | 100.0 |

pH: 5.5

Result:

The results of the preservative stress tests for Aspergillus niger for the active compound combinations investigated, comprising the mixture according to this invention (product C) or the comparison systems (products A and B), clearly show a synergistic effect of the mixture according to this invention (product C). In the case of Aspergillus niger, a germ which is particularly problematic in respect of preservation of industrial products, it was possible to reduce the number of colony-forming units (CFU) from 280000 to 200 within 7 days by using the mixture according to this invention (table 5, see below). In contrast, the active compound contained in product A (Imidazolidinyl Urea) in a dosage of 0.2 wt. % for comparison purposes rendered possible no such significant reduction in the number of colony-forming units (CFU after 7 days: 113000) in Aspergillus niger, which also applies to product B (tropolone, dosage: 0.01%; CFU after 7 days: 2000). This test series thus shows by way of example that the active compound mixtures according to this invention have an action which is significantly improved synergistically compared with products A (Imidazolidinyl Urea) and B (tropolone).

TABLE 5
Testing for adequate preservation for product A (comprising 0.2%
Imidazolidinyl Urea), for product B (comprising 0.01% tropolone)
and for product C (mixture according to this invention comprising
0.1% Imidazolidinyl Urea and 0.005% tropolone).

| | A | B | C |
|---|---|---|---|
| | 0.2% Imidazolidinyl | 0.01% | 0.10% Imidazolidinyl |
| | Urea | tropolone | Urea and 0.005% Tropolone |
| | CFU (colony-forming units) | | |
| | Aspergillus niger ATCC 16404 | | |
| 0′ count | 280000 | 280000 | 280000 |
| 2 d | 151000 | 72000 | 113000 |
| 7 d | 113000 | 2000 | 200 |
| 14 d | 95000 | 4800 | 0 |
| 28 d | 95000 | 100 | 0 |

The calculation of the SI value for treatment of Aspergillus niger with a mixture of Imidazolidinyl Urea and tropolone after an incubation phase of 7 days is shown below by way of example (Table 6, see below). The calculated SI of 0.0509 clearly shows that the mixture is a highly synergistic combination of active compounds. A 3 log reduction in Aspergillus niger CFU's (Colony Forming Units) within at least 7 days, which is a necessary prerequisite for adequate preservation, could be only achieved with product C comprising Imidazolidinyl Urea and tropolone. It was not possible to calculate the 14-day and 28-day SI values, since after this incubation phase the germ counts of product C was 0 (compare Table 5). In these special cases, Kull's equation cannot be used.

TABLE 6
Calculation of the synergy index (SI) at the time 7 days with the
aid of the CFU values for product A (Imidazolidinyl Urea; dosage:
0.2%), product B (tropolone; dosage: 0.01%) and for the synergistic
mixture according to this invention (ratio of amounts of product A
and product B: 1:1; w/w; dosage of Imidazolidinyl Urea: 0.1%;
dosage of tropolone: 0.005%); test germ: Aspergillus niger)

| | | | C |
|---|---|---|---|
| | | | 0.1% |
| | | | Imidazolidinyl |
| | A | | Urea |
| | 0.2% | B | and |
| | Imidazolidinyl | 0.01% | 0.005% |
| | Urea | tropolone | Topolone |
| Aspergillus niger: 7 days | 113000 | 2000 | 200 |
| [CFU/ml] | | | |

Kull's equation: SI = C × D/A + C × E/B

| | |
|---|---|
| A: Germ count for | 113000 |
| substance A | |
| B: Germ count for | 2000 |
| substance B | |
| C: Germ count for mixture | 200 |
| A + B | |
| D: Content of A in C | 0.5 |
| E: Content of B in C | 0.5 |
| SI: Synergy index | 0.0509 |

Outstanding results which confirm the superiority of product C according to this invention were likewise obtained in respect of the further test germs.

### EXAMPLE 3

Comparison of adequate preservation of cosmetic formulations comprising 2,3-imidazolidinedione,1,3-bis(hydroxymethyl)-5,5-dimethyl—(CARN: 006440-58-0; INCI: DMDM hydantoin; product A, comparative formulation), tropolone (product B, comparative formulation) and a mixture of DMDM hydantoin and tropolone (product C, formulation according of this invention)

Testing for adequate preservation was carried out in accordance with Example 1.

Aspergillus niger ATCC 16404 strain was used for the tests for adequate preservation, with an initial germ count (CFU/g; “0 value”) of 280 000.

Formulation:

For the tests for adequate preservation, a defined amount of the active compound combination according to this invention (product C) was incorporated into an O/W emulsion. For comparison purposes, the comparison products (product A and B) were incorporated into separate O/W emulsions.

TABLE 7
Formulations with products A, B and C:

| | | | Wt. % | | |
|---|---|---|---|---|---|
| | | | with | Wt. % | Wt. % |
| | INCI name | Manufacturer | “A” | with “B” | with “C” |
| Phase A | | | | | |
| Dracorin CE | Glyceryl | Symrise | 4.0 | 4.0 | 4.0 |
| 614035 | Stearate Citrate | | | | |
| PCL Solid | Stearyl | Symrise | 3.0 | 3.0 | 3.0 |
| 660086 | Heptanoate, | | | | |
| | Stearyl | | | | |
| | Caprylate | | | | |
| Paraffin oil °E | Paraffinum | Parafluid | 7.0 | 7.0 | 7.0 |
| | Liquidum | | | | |
| Lanette 18 | Stearyl Alcohol | Cognis | 1.5 | 1.5 | 1.5 |
| Dracorin GMS | Glyceryl | Symrise | 1.5 | 1.5 | 1.5 |
| 647834 | Stearate | | | | |
| Dow Corning 200 | Dimethicone | Dow Corning | 2.0 | 2.0 | 2.0 |
| fluid | | | | | |
| Phase B | | | | | |
| Water, | Water (Aqua) | | to 100 | to 100 | to 100 |
| demineralized | | | | | |
| Carbopol ETD | Carbomer | Noveon | 0.15 | 0.15 | 0.15 |
| 2050 Polymer | | | | | |
| 2,3- | DMDM | Lonza | 0.20 | — | 0.1 |
| Imidazolidinedione, | Hydantoin | | | | |
| 1,3- | | | | | |
| bis(hydroxymethyl)- | | | | | |
| 5,5-dimethyl- | | | | | |
| Tropolone | | Symrise | — | 0.01 | 0.005 |
| Phase C | | | | | |
| Neutralizer AMP- | Amino | Dow/Angus | 0.1 | 0.1 | 0.1 |
| 95 | Methylpropanol | | | | |
| Total: | | | 100.0 | 100.0 | 100.0 |

pH: 5.5

Result:

The results of the preservative stress tests for Aspergillus niger for the active compound combinations investigated, comprising the mixture according to this invention (product C) or the comparison systems (products A and B), clearly show a synergistic effect of the mixture according to this invention (product C). In the case of Aspergillus niger, a germ which is particularly problematic in respect of preservation of industrial products, it was possible to reduce the number of colony-forming units (CFU) from 280000 to 100 within 7 days by using the mixture according to this invention (table 8, see below). In contrast, the active compound contained in product A (DMDM Hydantoin) in a dosage of 0.2 wt. % for comparison purposes rendered possible no such significant reduction in the number of colony-forming units (CFU after 7 days: 13000) in Aspergillus niger, which also applies to product B (tropolone, dosage: 0.01%; CFU after 7 days: 2000). This test series thus shows by way of example that the active compound mixtures according to this invention have an action which is significantly improved synergistically compared with products A (DMDM Hydantoin) and B (tropolone).

TABLE 8
Testing for adequate preservation for product A (comprising 0.2%
DMDM Hydantoin), for product B (comprising 0.01% tropolone)
and for product C (mixture according to this invention comprising
0.1% DMDM Hydantoin and 0.005% tropolone).

| | | | C |
|---|---|---|---|
| | | | 0.10% DMDM |
| | A | B | Hydantoin |
| | 0.2% DMDM | 0.01% | and |
| | Hydantoin | tropolone | 0.005% Tropolone |
| | CFU (colony-forming units) | | |
| | Aspergillus niger ATCC | | |
| | 16404 | | |
| 0′ count | 280000 | 280000 | 280000 |
| 2 d | 189000 | 72000 | 132000 |
| 7 d | 13000 | 2000 | <100 |
| 14 d | 15000 | 4800 | 0 |
| 28 d | 6800 | 100 | 0 |

The calculation of the SI value for treatment of Aspergillus niger with a mixture of DMDM Hydantoin and tropolone after an incubation phase of 7 days is shown below by way of example (Table 9, see below). The calculated SI of 0.0288 clearly shows that the mixture is a highly synergistic combination of active compounds. A 3 log reduction in Aspergillus niger CFU's (Colony Forming Units) within at least 7 days, which is a necessary prerequisite for adequate preservation, could be only achieved with product C comprising DMDM Hydantoin and tropolone. It was not possible to calculate the 14-day and 28-day SI values, since after this incubation phase the germ counts of product C was either 0 or <100 (Table 8). In these special cases, Kull's equation cannot be used.

TABLE 9
Calculation of the synergy index (SI) at the time 7 days with the aid
of the CFU values for product A (DMDM Hydantoin; dosage: 0.2%),
product B (tropolone; dosage: 0.01%) and for the synergistic mixture
according to this invention (ratio of amounts of product A and
product B: 1:1; w/w; dosage of DMDM Hydantoin: 0.1%; dosage of
tropolone: 0.005%); test germ: Aspergillus niger)

| | | | C |
|---|---|---|---|
| | | | 0.1% DMDM |
| | A | | Hydantoin |
| | 0.2% | B | and |
| | DMDM | 0.01% | 0.005% |
| | Hydantoin | tropolone | Topolone |
| Aspergillus niger: 7 days | 13000 | 2000 | 100 |
| [CFU/ml] | | | |

Kull's equation: SI = C × D/A + C × E/B

| | |
|---|---|
| A: Germ count for substance | 13000 |
| A | |
| B. Germ count for substance | 2000 |
| B | |
| C: Germ count for mixture | 100 |
| A + B | |
| D: Content of A in C | 0.5 |
| E: Content of B in C | 0.5 |
| SI: Synergy index | 0.0288 |

Outstanding results which confirm the superiority of product C according to this invention were likewise obtained in respect of the further test germs.

### EXAMPLE 4

Comparison of adequate preservation of cosmetic formulations comprising 2-Ethylhexylglycerylether (CARN: 70445-33-9; INCI: ethylhexylglycerin; product A, comparative formulation), tropolone (product B, comparative formulation) and a mixture of ethylhexylglycerin and tropolone (product C, formulation according to this invention)

Testing for adequate preservation was carried out in accordance with the Example 1.

Aspergillus niger ATCC 16404 strain was used for the tests for adequate preservation, with an initial germ count (CFU/g; “0 value”) of 280 000.

Formulation:

The formulations A, B and C were prepared according to Example 1.

TABLE 10
Formulations with products A, B and C:

| | | | Wt. % | Wt. % | Wt. % |
|---|---|---|---|---|---|
| | | | with | with | with |
| | INCI name | Manufacturer | “A” | “B” | “C” |
| Phase A | | | | | |
| Dracorin CE | Glyceryl | Symrise | 4.0 | 4.0 | 4.0 |
| 614035 | Stearate Citrate | | | | |
| PCL Solid | Stearyl | Symrise | 3.0 | 3.0 | 3.0 |
| 660086 | Heptanoate, | | | | |
| | Stearyl | | | | |
| | Caprylate | | | | |
| Paraffin oil °E | Paraffinum | Parafluid | 7.0 | 7.0 | 7.0 |
| | Liquidum | | | | |
| Lanette 18 | Stearyl Alcohol | Cognis | 1.5 | 1.5 | 1.5 |
| Dracorin GMS | Glyceryl | Symrise | 1.5 | 1.5 | 1.5 |
| 647834 | Stearate | | | | |
| Dow Corning 200 | Dimethicone | Dow Corning | 2.0 | 2.0 | 2.0 |
| fluid | | | | | |
| Phase B | | | | | |
| Water, | Water (Aqua) | | to 100 | to 100 | to 100 |
| demineralized | | | | | |
| Carbopol ETD | Carbomer | Noveon | 0.15 | 0.15 | 0.15 |
| 2050 Polymer | | | | | |
| 2- | Ethylhexylglycerin | Schülke & | 0.50 | — | 0.25 |
| Ethylhexylglycerylether | | Mayr | | | |
| Tropolone | | Symrise | — | 0.01 | 0.005 |
| Phase C | | | | | |
| Neutralizer AMP- | Amino | Dow/Angus | 0.1 | 0.1 | 0.1 |
| 95 | Methylpropanol | | | | |
| Total: | | | 100.0 | 100.0 | 100.0 |

pH: 5.5

Result:

The results of the preservative stress tests for Aspergillus niger for the active compound combinations investigated, comprising the mixture according to this invention (product C) or the comparison systems (products A and B), clearly show a synergistic effect of the mixture according to this invention (product C). In the case of Aspergillus niger, a germ which is particularly problematic in respect of preservation of industrial products, it was possible to reduce the number of colony-forming units (CFU) from 280000 to 100 within 7 days by using the mixture according to this invention (table 11, see below). In contrast, the active compound contained in product A (Ethylhexylglycerin) in a dosage of 0.5 wt. % for comparison purposes rendered possible no such significant reduction in the number of colony-forming units (CFU after 7 days: 113000) in Aspergillus niger, which also applies to product B (tropolone, dosage: 0.01%; CFU after 7 days: 2000). This test series thus shows by way of example that the active compound mixtures according to this invention have an action which is significantly improved synergistically compared with products A (Ethylhexylglycerin) and B (tropolone).

TABLE 11
Testing for adequate preservation for product A (comprising 0.5%
Ethylhexylglycerin), for product B (comprising 0.01% tropolone)
and for product C (mixture according to this invention comprising
0.25% Ethylhexylglycerin and 0.005% tropolone).

| | | | C |
|---|---|---|---|
| | | | 0.25% |
| | A | B | Ethylhexylglycerin |
| | 0.5% | 0.01% | and |
| | Ethylhexylglycerin | tropolone | 0.005% Tropolone |
| | CFU (colony-forming units) | | |
| | Aspergillus niger ATCC 16404 | | |
| 0′ count | 280000 | 280000 | 280000 |
| 2 d | 189000 | 72000 | 113000 |
| 7 d | 113000 | 2000 | <100 |
| 14 d | 151000 | 4800 | 0 |
| 28 d | 246000 | 100 | 0 |

The calculation of the SI value for treatment of Aspergillus niger with a mixture of Ethylhexylglycerin and tropolone after an incubation phase of 7 days is shown below by way of example (Table 12, see below). The calculated SI of 0.0254 clearly shows that the mixture is a highly synergistic combination of active compounds. A 3 log reduction in Aspergillus niger CFU's (Colony Forming Units) within at least 7 days, which is a necessary prerequisite for adequate preservation, could be only achieved with product C comprising Ethylhexylglycerin and tropolone. It was not possible to calculate the 14-day and 28-day SI values, since after this incubation phase the germ counts of products B and C were either 0 or <100 (Table 11). In these special cases, Kull's equation cannot be used.

TABLE 12
Calculation of the synergy index (SI) at the time 7 days
with the aid of the CFU values for product A
(Ethylhexylglycerin; dosage: 0.5%), product B
(tropolone; dosage: 0.01%) and for the synergistic
mixture according to this invention (ratio of amounts of
product A and product B: 1:1; w/w; dosage of
Ethylhexylglycerin: 0.25%; dosage of tropolone: 0.005%);
test germ: Aspergillus niger)

| | | | C |
|---|---|---|---|
| | | | 0.25% |
| | A | | Ethylhexyl- |
| | 0.5% | B | glycerin and |
| | Ethylhexyl- | 0.01% | 0.005% |
| | glycerin | tropolone | Topolone |
| Aspergillus niger: 7 days | 113000 | 2000 | 100 |
| [CFU/ml] | | | |

Kull's equation: SI = C × D/A + C × E/B

| | |
|---|---|
| A: Germ count for | 113000 |
| substance A | |
| B: Germ count for | 2000 |
| substance B | |
| C: Germ count for | 100 |
| mixture A + B | |
| D: Content of A in C | 0.5 |
| E: Content of B in C | 0.5 |
| SI: Synergy index | 0.0254 |

Outstanding results which confirm the superiority of product C according to this invention were likewise obtained in respect of the further test germs.

### FORMULATION EXAMPLES F1-F14

Cosmetic formulations comprising mixtures of tropolone and chlorphenesin, tropolone and imidazolidinyl urea, tropolone and DMDM hydantoin or tropolone and ethylhexylglycerin.

Some efficiently preserved cosmetic formulations comprising mixtures of tropolone and chlorphenesin, tropolone and imidazolidinyl urea, tropolone and DMDM hydantoin or tropolone and ethylhexylglycerin according to this invention are given in the following formulations of Formula 1 to Formula 14.

Formulation F1: Anti-Wrinkle Cream

| Raw Material | % weight |
|---|---|
| Phase 1 | |
| Glyceryl Stearate Citrate | 1.00 |
| Glyceryl Laurate | 1.00 |
| Cetearyl Alcohol | 2.00 |
| Myristyl Myristate | 1.00 |
| Cetearyl Ethylhexanoate | 4.00 |
| Mineral oil | 4.00 |
| Cyclopentasiloxane, Cyclohexasiloxane | 0.50 |
| Acrylates/C10-30 Alkyl Acrylate Crosspolymer | 0.20 |
| Phase 2 | |
| Water | 82.99 |
| Xanthan Gum | 0.10 |
| 1,2-Hexanediol | 2.00 |
| Phase 3 | |
| Sodium Hydroxide 10% solution | 0.10 |
| Phase 4 | |
| Narcissus Tazetta Bulb Extract | 1.00 |
| Phase 5 | |
| Chlorphenesin | 0.10 |
| Tropolone | 0.01 |

Formulation F2: Anti-Inflammatory Lotion

| Raw Material | % weight |
|---|---|
| Phase 1 | |
| Cetearyl Alcohol, Ceteareth-20 | 3.50 |
| Cetearyl Alcohol | 0.50 |
| Stearyl Heptanoate, Stearyl Caprylate | 0.50 |
| Glyceryl Stearate | 1.00 |
| Cetearyl Ethylhexanoate | 4.00 |
| Mineral oil | 3.00 |
| Hydrogenated Coco-Glycerides | 1.00 |
| Phase 2 | |
| Water | 80.995 |
| Disodium EDTA | 0.10 |
| Xanthan Gum | 0.10 |
| Glycerin | 4.00 |
| Phase 3 | |
| Water, Glycerin, Avena Sativa (Oat) Kernel Extract | 1.00 |
| Phase 4 | |
| alpha-Bisabolol, Zingiber Officinale (Ginger) Root Extract | 0.10 |
| Phase 5 | |
| Chlorphenesin | 0.20 |
| Tropolone | 0.005 |

Formulation F3: Sunscreen Lotion

| Raw Material | % weight |
|---|---|
| Phase 1 | |
| Potassium Cetyl Phosphate, Hydrogenated Palm Glycerides | 1.00 |
| alpha-Bisabolol | 0.10 |
| Cetearyl Alcohol | 1.50 |
| Myristyl Myristate | 1.00 |
| Cetearyl Ethylhexanoate | 4.00 |
| Stearyl Heptanoate, Stearyl Caprylate | 1.00 |
| Cyclopentasiloxane, Cyclohexasiloxane | 0.50 |
| Butyl Methoxydibenzoylmethane | 1.50 |
| 4-Methylbenzylidene Camphor | 1.50 |
| Ethylhexyl Methoxycinnamate | 7.00 |
| VP/Hexadecene Copolymer | 1.00 |
| Acrylates/C10-30 Alkyl Acrylate Crosspolymer | 0.10 |
| Phase 2 | |
| Water | 75.58 |
| Pentylene Glycol (1,2-Pentanediol) | 3.00 |
| Phase 3 | |
| Sodium Hydroxide, 10% solution | 0.50 |
| Phase 4 | |
| Fragrance | 0.20 |
| Phase 5 | |
| Ethylhexylglycerin | 0.50 |
| Tropolone | 0.02 |

Formulation F4: Repairing Ointment

| Raw Material | % weight |
|---|---|
| Phase 1 | |
| Petrolatum | 60.199 |
| Mineral oil | 30.00 |
| Microcrystalline Wax | 3.00 |
| Beeswax | 5.00 |
| Phase 2 | |
| Zinc acetate | 0.10 |
| Phase 3 | |
| Hexyldecanol, alpha-Bisabolol, Cetylhydroxyproline | 1.00 |
| Palmitamide, Stearic Acid, Brassica Campestris | |
| (Rapeseed) Sterols | |
| Phase 4 | |
| 1,2-Hexanediol | 0.25 |
| 1,2-Octanediol (Caprylyl Glycol) | 0.25 |
| Phase 5 | |
| Ethylhexylglycerin | 0.20 |
| Tropolone | 0.001 |

Formulation F5: Hair Spray

| Raw Material | % weight |
|---|---|
| Phase 1 | |
| Water | 61.799 |
| Ethanol SD40 | 30.00 |
| Disodium EDTA | 0.10 |
| Pentylene Glycol (1,2-Pentanediol) | 2.00 |
| Phase 2 | |
| Polyquaternium-11 | 4.00 |
| Phase 3 | |
| DMDM Hydantoin | 0.10 |
| Tropolone | 0.001 |
| Phase 4 | |
| Water, Glycerin, Beta-Glucan | 2.00 |

Formulation F6: Soothing Powder

| Raw Material | % weight |
|---|---|
| Phase 1 | |
| Talc | 98.548 |
| Phase 2 | |
| Eucalyptus Oil | 0.05 |
| Phase 3 | |
| Zinc oxide | 1.00 |
| Menthol | 0.10 |
| Menthyl Lactate | 0.10 |
| Phase 4 | |
| Lavender oil | 0.10 |
| Phase 5 | |
| Imidazolidinyl Urea | 0.10 |
| Tropolone | 0.002 |

Formulation F7: Hair Styling Gel

| Raw Material | % weight |
|---|---|
| Phase 1 | |
| Water | 88.195 |
| PVM/MA Decadiene Crosspolymer | 0.60 |
| Phase 2 | |
| PVP | 3.00 |
| Pentylene Glycol (1,2-Pentandiol) | 3.00 |
| Isocetyl Stearate | 4.00 |
| Ethylhexyl Methoxycinnamate | 0.50 |
| Phase 3 | |
| Aminomethyl Propanol | 0.40 |
| Phase 4 | |
| Sodium hydroxymethylglycinate | 0.30 |
| Tropolone | 0.005 |

Formulation F8: Silicone Emulsion

| Raw Material | % weight |
|---|---|
| Phase 1 | |
| Potassium Cetyl Phosphate, Hydrogenated Palm Glycerides | 1.00 |
| Cyclohexasiloxane | 4.00 |
| Cetearyl Alcohol | 1.50 |
| Phenyl Trimethicone | 3.00 |
| Stearyl Heptanoate, Stearyl Caprylate | 3.00 |
| Dimethicone | 1.00 |
| Xanthan Gum | 0.20 |
| Isoamyl p-Methoxycinnamate | 5.00 |
| Phase 2 | |
| Water | 78.09 |
| Methylpropanediol | 3.00 |
| Phase 3 | |
| Diazolidinyl urea | 0.20 |
| Tropolone | 0.01 |

Formulation F9: Hair Conditioner

| Raw Material | % weight |
|---|---|
| Phase 1 | |
| Water | 90.999 |
| Polyquaternium-7 | 1.00 |
| Cetearyl Alcohol, Glyceryl Stearate, Stearalkonium Chloride | 4.50 |
| Citric Acid | 0.20 |
| Phase 2 | |
| Caprylyl Glycol (1,2-Octanediol) | 1.00 |
| Polysorbate 20 | 2.00 |
| Phase 3 | |
| Polyaminopropyl Biguanide | 0.10 |
| Tropolone | 0.001 |
| Phase 4 | |
| Fragrance | 0.20 |

Formulation F10: Shampoo

| Raw Material | % weight |
|---|---|
| Phase 1 | |
| Water | 66.40 |
| Acrylates/C10-30 Alkyl Acrylate Crosspolymer | 0.70 |
| Sodium Hydroxide 15% solution | 0.10 |
| Phase 2 | |
| Disodium EDTA | 0.10 |
| Decylene Glycol | 1.00 |
| Phase 4 | |
| Glycol Distearate, Laureth-4, Cocamidopropyl Betaine | 3.00 |
| Phase 4 | |
| Sodium Laureth Sulfate (2 mole, 53%) | 10.00 |
| Cocoamphoacetate | 5.00 |
| Ammonium Cocoyl Isethionate | 12.00 |
| Acetamide MEA | 1.00 |
| Palmitamide MEA | 0.50 |
| Phase 5 | |
| DMDM Hydantoin | 0.15 |
| Methylisothiazolinone | 0.04 |
| Tropolone | 0.01 |

Formulation F11: Anti-Perspirant Stick

| Raw Material | % weight |
|---|---|
| Phase 1 | |
| Stearyl Alcohol | 22.299 |
| Isopropyl Palmitate | 20.00 |
| Hydrogenated Castor Oil | 10.00 |
| Ethylhexylglycerin | 0.20 |
| Phase 2 | |
| Aluminum Zirconium Tetrachlorohydrex Glycine | 20.00 |
| Phase 3 | |
| Talc | 2.00 |
| Phase 4 | |
| Cyclpentasiloxane | 20.00 |
| Dimethiconol Beeswax | 5.00 |
| Phase 5 | |
| 4-Methyl-4-Phenyl-2-Pentanol | 0.50 |
| Tropolone | 0.001 |

Formulation F12: Lotion Base for Wet Wipes (Emulsion)

| Raw Material | % weight |
|---|---|
| Phase 1 | |
| Cetearyl Isononanoate, Ceteareth-20, Stearyl Alcohol, | 3.00 |
| Glyceryl Stearate, Glycerin, Ceteareth-12, Cetyl Palmitate | |
| Mineral Oil | 3.00 |
| Phase 2 | |
| Water | 91.595 |
| Glycerin | 0.50 |
| Propylene Glycol | 1.00 |
| Dimethyl Phenylpropanol | 0.50 |
| Allantoin | 0.10 |
| Phase 3 | |
| Imidazolidinyl urea | 0.15 |
| Benzethonium Chloride | 0.05 |
| Tropolone | 0.005 |
| Phase 4 | |
| Lavender oil | 0.10 |

Formulation F13: Base for Wet Wipes (Solution)

| Raw Material | % weight |
|---|---|
| Phase 1 | |
| Water | 89.199 |
| Propylene Glycol | 8.00 |
| Citric Acid 10% | 0.10 |
| Phase 2 | |
| Solubilizer (PEG-40 Hydrogenated Castor Oil, | 2.00 |
| Trideceth-9, Propylene Glycol Water) | |
| Fragrance | 0.10 |
| Phase 3 | |
| 2-Bromo-2-Nitropropane-1,3-Diol | 0.05 |
| Tropolone | 0.001 |
| Diazolidinyl urea | 0.05 |
| Phase 4 | |
| Chamomile extract | 0.50 |

Formulation F14: W/O Sunscreen Lotion

| Raw Material | % weight |
|---|---|
| Phase 1 | |
| Polyglyceryl-2 Dipolyhydroxystearate | 3.00 |
| Glyceryl Oleate | 1.00 |
| Beeswax | 1.20 |
| Ethylhexyl Isononanoate | 2.00 |
| Caprylic/Capric Triglyceride | 3.00 |
| C12-15 Alkyl Benzoate | 3.00 |
| Benzophenone-3 | 6.00 |
| Homosalate | 10.00 |
| Ethylhexyl Salicylate | 5.00 |
| Butyl Methoxydibenzoylmethane | 3.00 |
| Ethylhexyl Methoxycinnamate | 7.50 |
| Phase 2 | |
| Water | 53.08 |
| 1,2-Hexanediol | 0.25 |
| Caprylyl Glycol (1,2-Octanediol) | 0.25 |
| Phase 3 | |
| Magnesium Sulfate | 0.70 |
| Phase 4 | |
| Sodium Chloride | 0.50 |
| Phase 5 | |
| Ethylhexylglycerin | 0.30 |
| Phenoxyethanol | 0.20 |
| Tropolone | 0.02 |

1. An antimicrobial mixture consisting of:
(a) one, two or more tropolone derivatives of the formula (1) 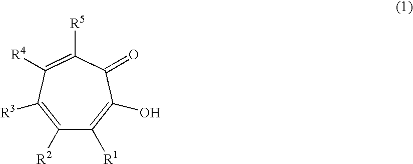
wherein the substituents R¹, R², R³, R⁴, R⁵ independently of one another have the following meaning:
H; linear or branched, saturated or unsaturated, aliphatic hydrocarbon radical having up to 30 C atoms; OH; OR⁶, wherein R⁶ is a linear or branched, saturated or unsaturated, aliphatic hydrocarbon radical having up to 30 C atoms; COOH; COOR⁷, wherein R⁷ is a linear or branched, saturated or unsaturated, aliphatic hydrocarbon radical having up to 30 C atoms; NO₂, NH₂, F, Cl, Br or I
or
salts or solvates thereof
and
(b) one or more compounds selected from the group consisting of: chlorphenesin, imidazolidinyl urea, DMDM hydantoin, ethylhexylglycerin, diazolidinyl urea, sodium hydroxymethylglycinate and polyaminopropyl biguanide
or
salts or solvates thereof.

2. The antimicrobial mixture according to claim 1,
wherein in constituent (a) the or one, two, three or four of the tropolone derivatives of formula (1) are selected from the group consisting of:
tropolone, alpha-thujaplicin, beta-thujaplicin and gamma-thujaplicin.

3. The antimicrobial mixture according to claim 1, wherein in constituent (a) the or one of the components is tropolone.

4. The antimicrobial mixture according to claim 1, wherein in constituent (b) one or more components are selected from the group consisting of:
chlorphenesin, imidazolidinyl urea, DMDM hydantoin and ethylhexylglycerin
or
salts or solvates thereof.

5. The antimicrobial mixture according to claim 1, comprising an amount of constituent (a) in the range of 0.001-10 wt. %, based on the amount of constituent (b).

6. The antimicrobial mixture according to claim 1, comprising one or more additional constituents (c) selected from the group consisting of:
methylchloroisothiazolinone, methylisothiazolinone, chlorohexidine, benzethonium chloride, 2-bromo-2-nitropropane-1,3-diol, methylpropanediol, dimethyl phenylpropanol and 4-methyl-4-phenyl-2-pentanol
or
salts or solvates thereof.

7. A cosmetic or pharmaceutical formulation or foodstuff comprising
an antimicrobial mixture comprising or consisting of constituents (a) and (b) according to claim 1 and
further conventional constituents,
the total amount of constituents (a) and (b) being in the range of from 0.01 to 10 wt. %, based on the total weight of the formulation or of the foodstuff.

8. The antimicrobial mixture according to claim 1 or a formulation or foodstuff comprising an antimicrobial mixture comprising or consisting of constituents (a) and (b) according to claim 1 and further conventional constituents, wherein the total amount of constituents (a) and (b) being in the range of from 0.01 to 10 wt. %, based on the total weight of the formulation or of the foodstuff,
wherein the amount of constituent (a) and/or the amount of constituent (b) in each case considered in itself is not antimicrobially active, but the total amount of constituents (a) and (b) is antimicrobially active.

9. A method for inhibiting microbial growth comprising applying an antimicrobial mixture according to claim 1.

10. A method for the preservation or antimicrobial treatment of a perishable product, comprising:
bringing the perishable product into contact with an antimicrobially active amount of a mixture according to claim 1 or a pharmaceutical formulation or foodstuff comprising an antimicrobial mixture comprising or consisting of constituents (a) and (b) according to claim 1 and further conventional constituents, wherein the total amount of constituents (a) and (b) being in the range of from 0.01 to 10 wt. %, based on the total weight of the formulation or of the foodstuff.

11. A method for the cosmetic and/or therapeutic treatment of
(i) microorganisms which cause body odor,
(ii) microorganisms which cause acne, and/or
(iii) microorganisms which cause mycoses,
comprising topical application of an antimicrobially active amount of a mixture according to claim 1 or a pharmaceutical formulation or foodstuff comprising an antimicrobial mixture comprising or consisting of constituents (a) and (b) according to claim 1 and further conventional constituents, wherein the total amount of constituents (a) and (b) being in the range of from 0.01 to 10 wt. %, based on the total weight of the formulation or of the foodstuff.

12. The method of claim 10, wherein the antimicrobially active amount is an amount which is active against Aspergillus niger.
